(19) United States
(12) Patent Application Publication
(10) Pub. No.: US 2013/0346867 A1
(43) Pub. Date: Dec. 26, 2013

(54) SYSTEMS AND METHODS FOR AUTOMATICALLY GENERATING A MEDIA ASSET SEGMENT BASED ON VERBAL INPUT

(71) Applicants: Thomas Steven Woods, Arlington Heights, IL (US); William J. Korbecki, Crystal Lake, IL (US); Jonathan Arme, Frankfort, IL (US); Brian Craig Peterson, Barrington, IL (US)

(72) Inventors: Thomas Steven Woods, Arlington Heights, IL (US); William J. Korbecki, Crystal Lake, IL (US); Jonathan Arme, Frankfort, IL (US); Brian Craig Peterson, Barrington, IL (US)

(73) Assignee: UNITED VIDEO PROPERTIES, INC., Santa Clara, CA (US)

(21) Appl. No.: 13/531,676

(22) Filed: Jun. 25, 2012

(51) Int. Cl. G06F 15/16; G06F 3/16

(52) U.S. Cl. 715/728

(57) ABSTRACT

Systems and methods for automatically generating a media asset segment based on verbal input are provided. Verbal input is received from a user while a media asset is being presented to the user. The verbal input is processed to extract an instruction and comment information included in the verbal input. The instruction is cross-referenced with a command database to determine whether the instruction corresponds to a segment generation command. In response to determining the instruction corresponds to the segment generation command, a segment that includes a portion of the media asset that was presented to the user when the verbal input was received is generated. The comment information is associated with the generated segment. A message that includes the generated segment and the associated comment information is transmitted to a remote server.

### BACKGROUND

Traditional systems allow users to manually create and share interesting segments of a media asset. However, oftentimes to share these segments the user has to remember the exact time and place the segments occurred to create and share them. Specifically, the user has to play back the media asset up to a point of interest and then creates the segment to share. This tedious time-consuming task usually causes the user to miss segments he/she would have otherwise liked to share. In addition, segments that are time sensitive (e.g., lose value as time progresses) are negatively impacted by the amount of time required for the user to manually find and create these segments.

### SUMMARY

In view of the foregoing, systems and methods for automatically generating a media asset segment based on verbal input in accordance with various embodiments of the present invention are provided.

In some embodiments, verbal input from a user is received while a media asset is being presented to the user. The verbal input is processed to extract an instruction and comment information included in the verbal input. In particular, the verbal input may include some words/phrases that correspond to instructions and some that correspond to commentary. A voice recognition engine 316 may parse the verbal input to generate a string of words/phrases and transmit a query to a database to identify which of the words/phrases correspond to instructions. The database may return an indication of which words/phrases correspond to an instruction.

In some embodiments, the instruction that includes the words/phrases may be cross-referenced with a command database to determine whether the instruction corresponds to a segment generation command. Specifically, entries in a command database are analyzed to determine whether the words/phrases correspond to a media asset segment command or another media guide function. In response to determining the instruction corresponds to the segment generation command, a segment is generated that includes a portion of the media asset that was presented to the user when the verbal input was received. In particular, when the media asset was being recorded prior to receiving the verbal input, the portion of the media asset that was presented at the time the verbal input was received is retrieved. The portion may include a portion of the media asset that was presented a predetermined amount of time before the verbal input was received and a portion of the media asset that was presented a predetermined amount of time after the verbal input was received. When the media asset was not being recorded prior to receiving the verbal input, the media asset starts being recorded or stored in response to receiving the verbal input for a predetermined amount of time after the verbal input was received to generate the media asset segment.

In some embodiments, the words/phrases in the verbal input that do not correspond to the instruction may be identified as commentary or comment information. The comment information may be associated with the generated segment. A message that includes the generated segment and the associated comment information is transmitted to a remote server. In particular, an email or IP package may be transmitted to a social network site or blog that includes the segment and associated comment information and posted to the social network associated with the user.

In some embodiments, biometric information from a plurality of users is received while a media asset is being presented to the users. The biometric information may include data that indicates a change in position in the users' faces and conversation taking place between the users. The biometric information is processed to determine whether the biometric information corresponds to a shareable moment. In particular, a biometric response engine may analyze the biometric information to determine whether two or more users turned their faces away from the screen and started talking. The biometric response engine may transmit a query to a database that includes monitored biometric response information to identify an instruction that corresponds to the given biometric response information. The database may return an indication of whether the biometric response corresponds to a shareable moment or another event.

In response to determining the biometric information corresponds to the shareable moment, a segment is generated that includes a portion of the media asset that was presented to the user when the biometric information was received. In particular, when the media asset was being recorded prior to receiving the biometric information, the portion of the media asset that was presented at the time the biometric information was received is retrieved. The portion may include a portion of the media asset that was presented a predetermined amount of time before the biometric information was received and a portion of the media asset that was presented a predetermined amount of time after the biometric information was received. When the media asset was not being recorded prior to receiving the biometric information, the media asset starts being recorded or stored in response to receiving the biometric information for a predetermined amount of time after the biometric information was received to generate the media asset segment.

In some embodiments, the words/phrases may be extracted from the biometric information, processed and stored as commentary or comment information. The comment information may be associated with the generated segment. A message that includes the generated segment and the associated comment information is transmitted to a remote server. In particular, an email or IP package may be transmitted to a social network site or blog that includes the segment and associated comment information and posted to the social network associated with the user.

In some embodiments, a request from a user to generate a media asset segment is received while a media asset is being presented to the user. The request may be in the form of a selection of a like option. In response to receiving the request, a segment is generated that includes a portion of the media asset that was presented to the user when the request was received. In particular, when the media asset was being recorded prior to receiving the request, the portion of the media asset is retrieved that was presented at the time the request was received until a request to stop generating the media asset segment is received. When the media asset was not being recorded prior to receiving the request, the media asset starts being recorded or stored in response to receiving the request until a request to stop generating the media asset segment is received to generate the media asset segment.

In some embodiments, comment information may be requested or received from the user in response to a request to stop generating the media asset segment. Words/phrases may be received from the user in the form of verbal input or textual entry and may be identified as commentary or comment information. The comment information may be associated with the generated segment. A message that includes the generated segment and the associated comment information is transmitted to a remote server. In particular, an email or IP package may be transmitted to a social network site or blog that includes the segment and associated comment information and posted to the social network associated with the user.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which:

FIGS. 1 and 2 show illustrative display screens that may be used to provide media guidance application listings in accordance with an embodiment of the invention;

FIG. 3 shows an illustrative user equipment device in accordance with another embodiment of the invention;

FIG. 4 is a diagram of an illustrative cross-platform interactive media system in accordance with another embodiment of the invention;

FIG. 5 shows an illustrative display screen of automatically generating a media asset segment based on verbal input in accordance with an embodiment of the invention;

FIG. 6 shows an illustrative display screen of a prompt for an automatically generated media asset segment in accordance with an embodiment of the invention;

FIG. 7 shows an illustrative display screen of automatic segment generation based on user input in accordance with an embodiment of the invention;

FIG. 8 shows an illustrative display screen of a prompt for an automatically generated media asset segment in accordance with an embodiment of the invention; and

FIGS. 9 and 10 are diagrams of a process for automatically generating a media asset segment in accordance with embodiments of the invention.

### DETAILED DESCRIPTION

The amount of content available to users in any given content delivery system can be substantial. Consequently, many users desire a form of media guidance through an interface that allows users to efficiently navigate content selections and easily identify content that they may desire. An application that provides such guidance is referred to herein as an interactive media guidance application or, sometimes, a media guidance application or a guidance application.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content or media assets. Interactive media guidance applications may generate graphical user interface screens that enable a user to navigate among, locate and select content. As referred to herein, the terms “media asset” and “content” should be understood to mean an electronically consumable user asset, such as television programming, as well as pay-per-view programs, on-demand programs (as in video-on-demand (VOD) systems), Internet content (e.g., streaming content, downloadable content, webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. Various devices and platforms that may implement media guidance applications are described in more detail below.

One of the functions of the media guidance application is to provide media guidance data to users. As referred to herein, the phrase, “media guidance data” or “guidance data” should be understood to mean any data related to content, such as media listings, media-related information (e.g., broadcast times, broadcast channels, titles, descriptions, ratings information (e.g., parental control ratings, critic's ratings, etc.), messages from a crowd of users on a social network, messages from a crowd of users posted to a blog or website, genre or category information, actor information, logo data for broadcasters' or providers' logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections. In some implementations, this data may be referred to as a data feed. As referred to herein the term “crowd” should be understood to mean any number of users greater than one.

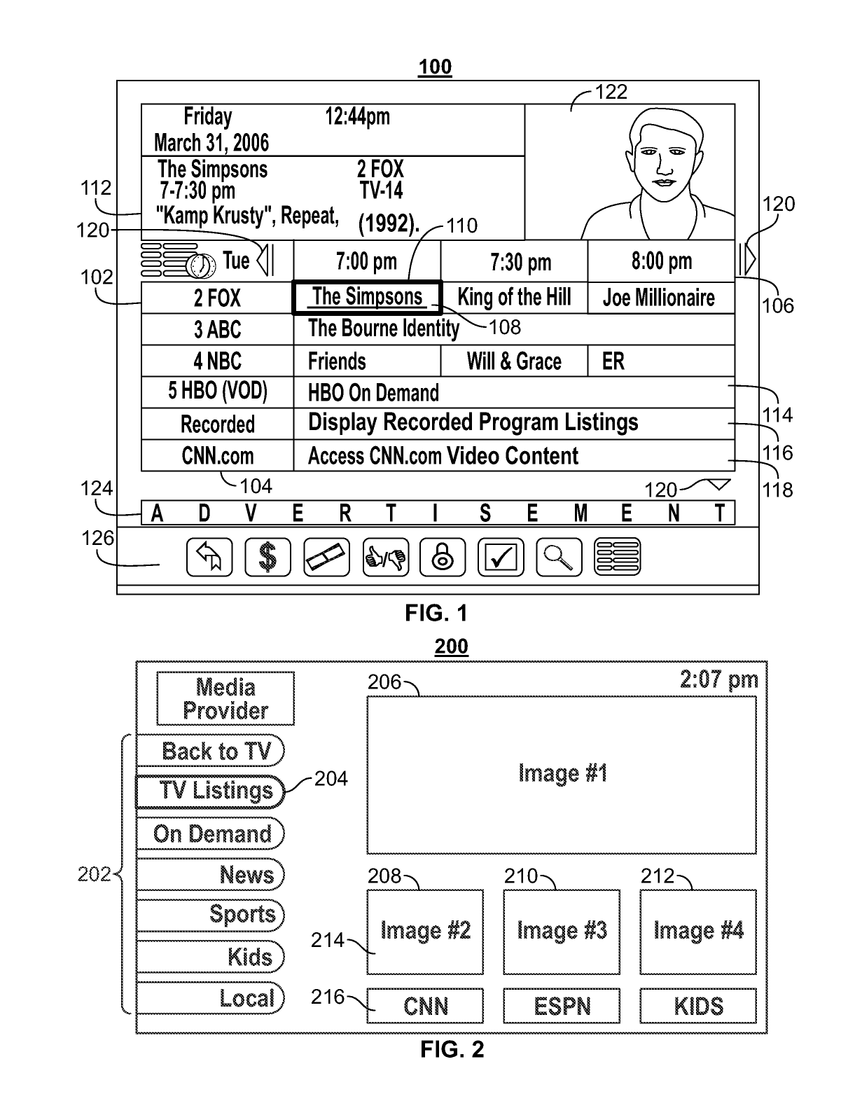

FIGS. 1-2 show illustrative display screens that may be used to provide media guidance data. The display screens shown in FIGS. 1-2 and 5-8 may be implemented on any suitable user equipment device or platform. While the displays of FIGS. 1-2 and 5-8 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria. The organization of the media guidance data is determined by guidance application data. As referred to herein, the phrase, “guidance application data” should be understood to mean data used in operating the guidance application, such as program information, guidance application settings, user preferences, or user profile information.

As referred to herein, the phrase “in response” should be understood to mean automatically, directly and immediately as a result of, without further input from the user, or automatically based on the corresponding action where intervening inputs or actions may occur.

FIG. 1 shows illustrative grid program listings display 100 arranged by time and channel that also enables access to different types of content in a single display. Display 100 may include grid 102 with: (1) a column of channel/content type identifiers 104, where each channel/content type identifier (which is a cell in the column) identifies a different channel or content type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to, or alternative to, providing access to linear programming (e.g., content that is scheduled to be transmitted to a plurality of user equipment devices at a predetermined time and is provided according to a schedule), the media guidance application may also provide access to non-linear programming (e.g., content accessible to a user equipment device at any time and not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L. P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet website or other Internet access (e.g. FTP).

Grid 102 may provide media guidance data for non-linear programming including on-demand listing 114, recorded content listing 116, and Internet content listing 118. A display combining media guidance data for content from different types of content sources is sometimes referred to as a “mixed-media” display. Various permutations of the types of media guidance data that may be displayed that are different from display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 124 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 102. Advertisement 124 may also be for products or services related or unrelated to the content displayed in grid 102. Advertisement 124 may be selectable and provide further information about content, provide information about a product or a service, enable purchasing of content, a product, or a service, provide content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, III et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 126 may allow the user to access different types of content, media guidance application displays, and/or media guidance application features. Options region 126 may be part of display 100 (and other display screens described herein), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other airtimes or ways of receiving a program, recording a program, enabling series recording of a program, setting program and/or channel as a favorite, purchasing a program, identifying media asset segment start and end times, performing a fast-access playback operation, performing a jump segment operation or skip commercials operation, or other features. Options available from a main menu display may include search options, VOD options (e.g., fast-access playback operations), parental control options, Internet options, cloud-based options, device synchronization options, like options, second screen device options, options to access various types of media guidance data displays, options to subscribe to a premium service, options to edit a user's profile, options to access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

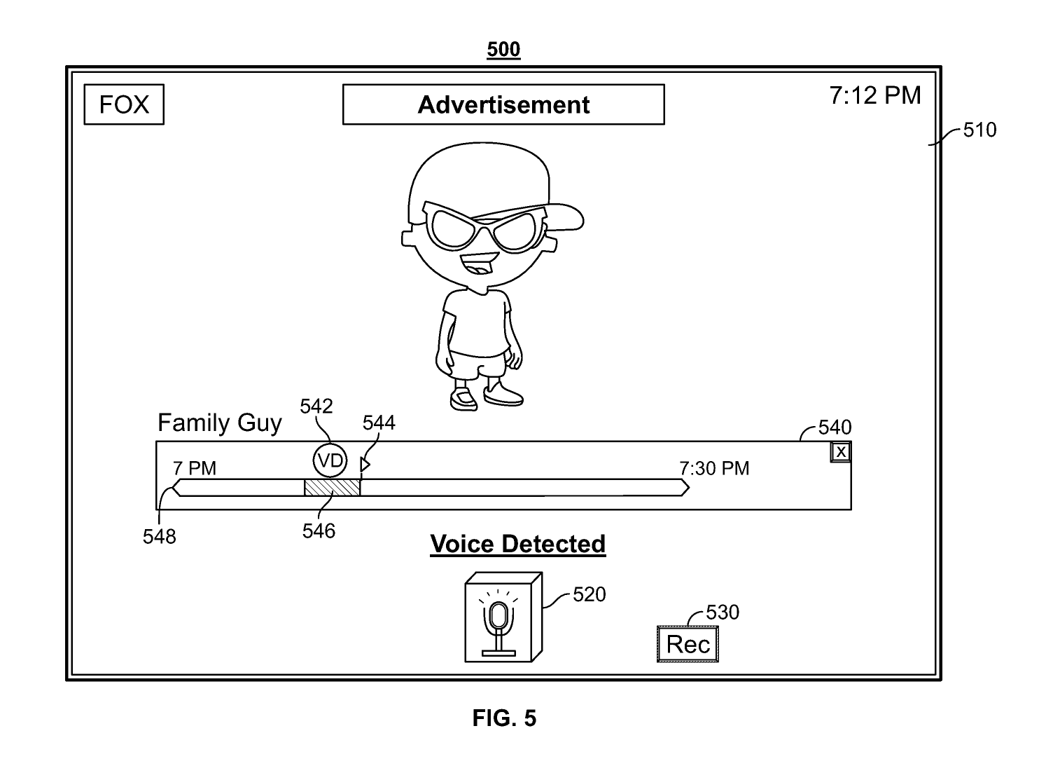

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other websites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. The user profile information may include identifiers of one or more social networks or blogs the user is associated with. For each social network or blog a username and password (e.g., log-in information) may be stored in the user profile information. Control circuitry 304 may utilize this information in the user profile to automatically access the social network or blog to post or transmit information/content/segments to or retrieve information/contents/segments from the social network or blog. This type of user experience is described in greater detail below in connection with FIG. 4. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 2. Video mosaic display 200 includes selectable options 202 for content information organized based on content type, genre, and/or other organization criteria. In display 200, television listings option 204 is selected, thus providing listings 206, 208, 210, and 212 as broadcast program listings. In display 200 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 208 may include more than one portion, including media portion 214 and text portion 216. Media portion 214 and/or text portion 216 may be selectable to view content in full-screen or to view information related to the content displayed in media portion 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Dec. 29, 2005, which is hereby incorporated by reference herein in its entirety.

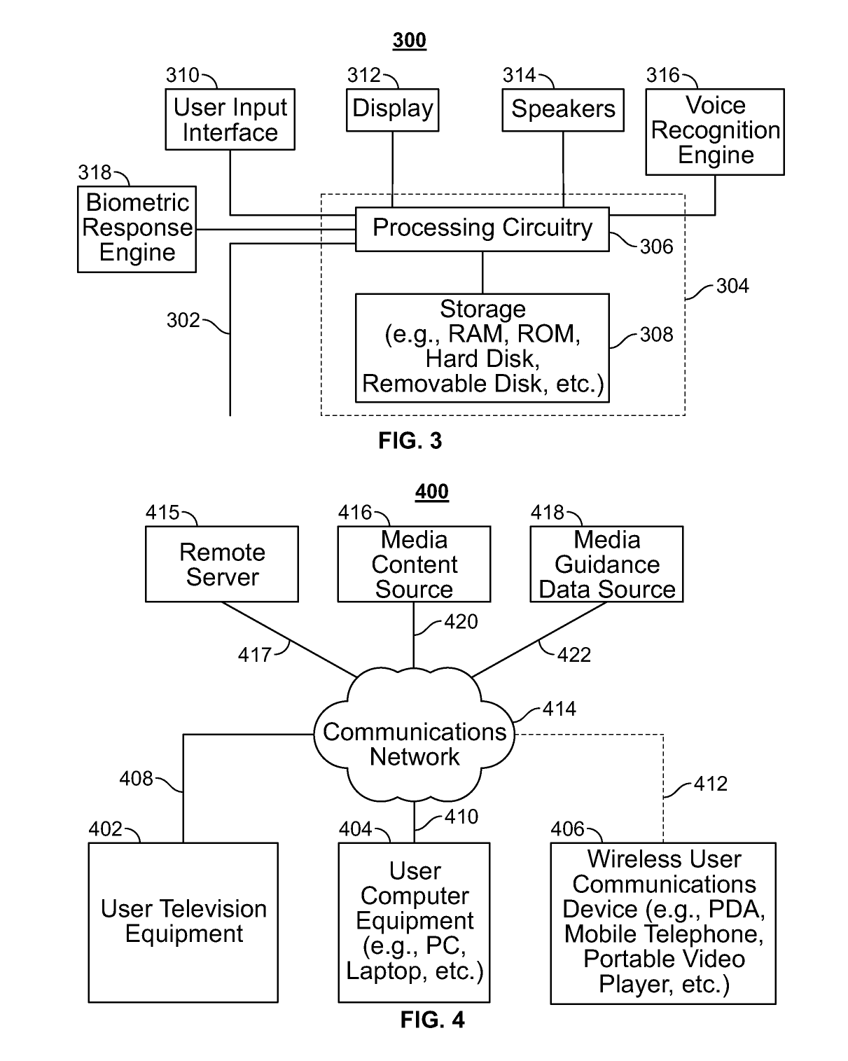

Users may access content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

In some embodiments, a viewing history may be stored in storage 308 for a user. The viewing history may include indications of which media assets have been viewed by a given user. The viewing history may also include, for each media asset, which portion or portions have or have not been viewed by the user. In some implementations, the viewing history may include indications of which users in a group of users have seen or viewed a media asset or a particular segment of a media asset. The group of users may be users in a certain geographical location (e.g., in the same home) or users that are associated with each other on a social network.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308). Specifically, control circuitry 304 may be instructed by the media guidance application to perform the functions discussed above and below. For example, the media guidance application may provide instructions to control circuitry 304 to generate the media guidance displays. In some implementations, any action performed by control circuitry 304 may be based on instructions received from the media guidance application.

In some embodiments, control circuitry 304 may include voice or verbal input processing circuitry, such as a voice recognition engine 316. This voice or verbal input processing circuitry may include any interface that performs a voice recognition process. Control circuitry 304 may continuously or periodically access the microphone of user input interface 310 to detect the presence of voice input. Upon detecting voice input, control circuitry 304 may utilize voice recognition engine 316 (implemented in software or with dedicated circuitry) to identify words/phrases in the voice input. As used herein, voice input and verbal input are interchangeable terms and should be understood to have the same meaning. The voice recognition process may perform analog-to-digital conversion on the voice input and process the digital information to form a digital representation of the voice input (e.g., a digital sentence with the identified words/phrases). The voice recognition process may output to another component of control circuitry 304 the identified or extracted words or phrases for further processing. In some implementations, voice recognition engine 316 may be implemented to only respond to a voice received from a particular user or group of users. For example, in an environment where multiple users are present and from whom all of their voices are received by user input interface 310, control circuitry 304 may only respond to one or a selected few of the voices. This way, only one or the selected members of the users can be authorized to provide instructions using verbal commands to control circuitry 304.

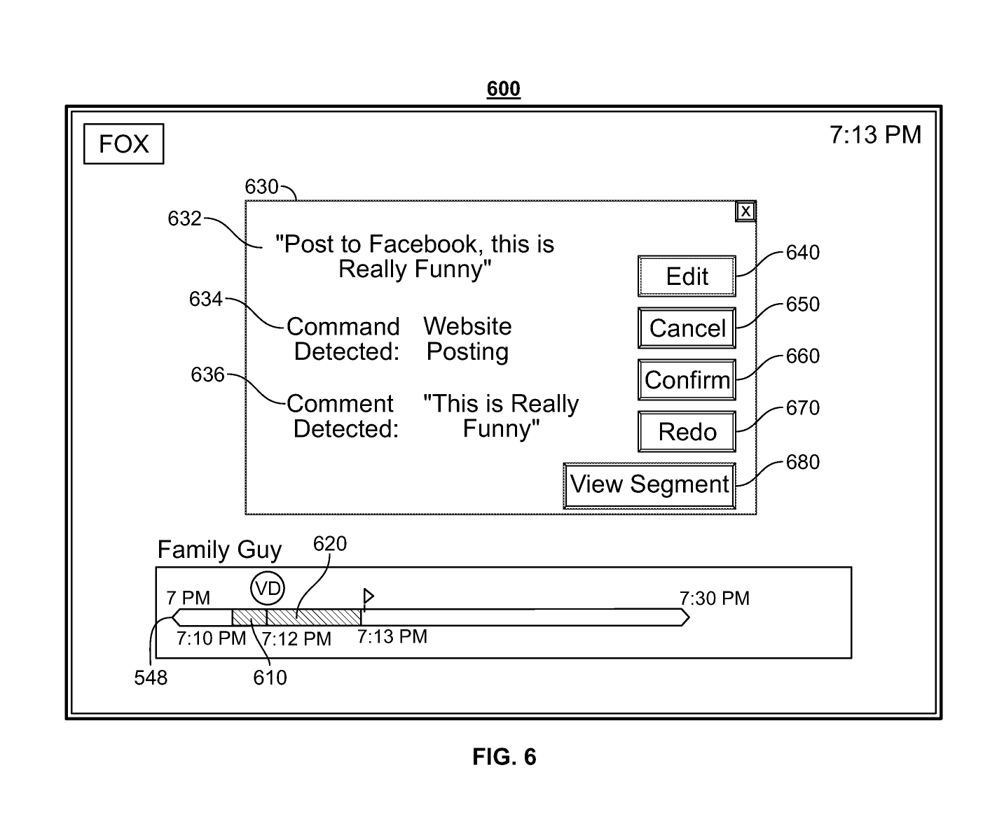

In some embodiments, voice recognition engine 316 may include a voice command database. Voice command database may include a list of words/phrases and a corresponding set of instructions for each word/phrase. In response to receiving a verbal input from a user, voice recognition engine 316 may process the verbal input to extract words/phrases from the verbal input. Voice recognition engine 316 may cross-reference the identified words/phrases with the voice command database to retrieve the corresponding set of instructions for the identified words/phrases. For example, the voice command database may include an entry with the phrase “post to Facebook” or any variation thereof. The phrase “post to Facebook” may correspond to a set of instructions that instruct control circuitry 304 to automatically generate a segment of the media asset being currently presented (discussed below in FIGS. 5-9) and post or transmit the generated segment to a social network or blog. This way, the segment may be shared with a network or group of members associated with the user (e.g., friends on a social network). Similarly, the voice command database may include an entry with the phrase “share with friends” or any variation thereof. The phrase “share with friends” may correspond to a set of instructions that instruct control circuitry 304 to automatically generate a segment of the media asset being currently presented (discussed below in FIGS. 5-9) and prepare and send an email MMS, or text message with the generated segment to a predefined group of friends associated with the user.

In some embodiments, control circuitry 304 may include a biometric response engine 318. Biometric response engine 318 may include circuitry that remotely or directly monitors a user's physiological and physical responses to content being presented. For example, biometric response engine 318 may include a heart pulse rate monitor, facial expression or position detection circuitry, eye movement and position detection circuitry, breathing pattern detection circuitry, user position and orientation detection circuitry, and/or any combination thereof. Control circuitry 304 may continuously or periodically access biometric response engine 318 to detect any changes in physiological and/or physical attributes of a user at or during specified sections of a media content being presented. Upon detecting a change in the biometric response of the user, control circuitry 304 may utilize a biometric response database to identify a corresponding set of instructions to perform. In some implementations, biometric response engine 318 may be implemented to respond only to biometric responses of a particular user or group of users. For example, in an environment where multiple users are present and from whom all of their biometric responses are received, control circuitry 304 may respond to only one or a selected few of the biometric responses.

The biometric response database may include a mapping between a given biometric response and a set of instructions for processing by control circuitry 304. For example, a biometric response entry in the biometric response database may include a voice command keyword (e.g., playback, pause, record, rewind, fast-forward, change channel, channel up, channel down, access source 1, access source 2) and the corresponding instructions may be stored for the entry that instruct control circuitry 304 to perform the function identified by the keyword. For example, a biometric response entry in the biometric response database may include a voice command keyword “post to Facebook” and the corresponding instructions may be stored for the entry that instruct control circuitry 304 generate a segment for the media asset being accessed and transmit the segment to a social network site or server associated with the user. In some implementations, voice recognition engine 316 may determine the identity of the user who provided the voice command to “post to Facebook” and may automatically retrieve a profile associated with the identified user to access the social network site associated with the user to transmit and post the media segment.

In some implementations, the biometric response database entry may include a combination of biometric responses and corresponding instruction. For example, a biometric response entry in the biometric response database may include a detection or determination that two or more users have engaged in a conversation (e.g., looked away from the screen at a given moment and exchanged verbal utterances) and the corresponding instructions may be stored for the entry that instruct control circuitry 304 to generate a segment for the media asset being accessed and transmit the segment to a social network site or server associated with the user or users engaged in the conversation. This may be referred to as a “shareable moment.” Specifically, two or more users may be viewing a given media asset and at a particular point in time, an event in the media asset happens that causes the users to engage in conversation. In response, biometric response engine 318 may identify this moment as the shareable moment and may automatically generate a media asset segment that includes the portion of the media asset presented to the users at the point in time for transmission to a social network site or blog.

In client-server-based embodiments, control circuitry 304 may include communications circuitry suitable for communicating with a guidance application server or other networks or servers. The instructions for carrying out the above-mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which are described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance information, described above, and guidance application data, described above. Nonvolatile memory may also be used (e.g., to launch a boot-up routine and other instructions). Cloud-based storage, described in relation to FIG. 4, may be used to supplement storage 308 or instead of storage 308.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may send instructions to control circuitry 304 using user input interface 310. User input interface 310 may be any suitable user interface, such as a remote control, mouse, trackball, keypad, keyboard, microphone, touch screen, touchpad, stylus input, joystick, voice recognition interface, or other user input interfaces. User input interface 310 may include keys or displayed options that enable a user to instruct control circuitry 304 to mark a segment as a liked segment (e.g., to start/stop marking of a liked segment). Display 312 may be provided as a stand-alone device or integrated with other elements of user equipment device 300. Display 312 may be one or more of a monitor, a television, a liquid crystal display (LCD) for a mobile device, or any other suitable equipment for displaying visual images. In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

The guidance application may be implemented using any suitable architecture. For example, it may be a stand-alone application wholly implemented on user equipment device 300. In such an approach, instructions of the application are stored locally, and data for use by the application is downloaded on a periodic basis (e.g., from an out-of-band feed, from an Internet resource, or using another suitable approach). In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a stand-alone device or may be part of a network of devices. Various network configurations of devices may be implemented and are discussed in more detail below.

A user equipment device utilizing at least some of the system features described above in connection with FIG. 3 may not be classified solely as user television equipment 402, user computer equipment 404, or a wireless user communications device 406. For example, user television equipment 402 may, like some user computer equipment 404, be Internet-enabled allowing for access to Internet content, while user computer equipment 404 may, like some television equipment 402, include a tuner allowing for access to television programming. The media guidance application may have the same layout on various different types of user equipment or may be tailored to the display capabilities of the user equipment. For example, on user computer equipment 404, the guidance application may be provided as a website accessed by a web browser. In another example, the guidance application may be scaled down for wireless user communications devices 406.

In system 400, there is typically more than one of each type of user equipment device but only one of each is shown in FIG. 4 to avoid overcomplicating the drawing. In addition, each user may utilize more than one type of user equipment device and also more than one of each type of user equipment device.

In some embodiments, a user equipment device (e.g., user television equipment 402, user computer equipment 404, wireless user communications device 406) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the website www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Each user of the user equipment devices may be associated with different users in a crowd of users. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes content source 416 and media guidance data source 418 coupled to communications network 414 via communication paths 420 and 422, respectively. Paths 420 and 422 may include any of the communication paths described above in connection with paths 408, 410, and 412. Communications with the content source 416 and media guidance data source 418 may be exchanged over one or more communications paths, but are shown as a single path in FIG. 4 to avoid overcomplicating the drawing. In addition, there may be more than one of each of content source 416 and media guidance data source 418, but only one of each is shown in FIG. 4 to avoid overcomplicating the drawing. (The different types of each of these sources are discussed below.) If desired, content source 416 and media guidance data source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 416 may be the originator of content (e.g., a television broadcaster, a Webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 418 may provide media guidance data, such as the media guidance data described above. Media guidance application data may be provided to the user equipment devices using any suitable approach. In some embodiments, the guidance application may be a stand-alone interactive television program guide that receives program guide data via a data feed (e.g., a continuous feed or trickle feed).

Program schedule data and other guidance data may be provided to the user equipment on a television channel sideband, using an in-band digital signal, using an out-of-band digital signal, or any other suitable data transmission technique. Program schedule data and other media guidance data may be provided to user equipment on multiple analog or digital television channels.

In some embodiments, guidance data from media guidance data source 418 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 418 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 418 may provide user equipment devices 402, 404, and 406 the media guidance application itself or software updates for the media guidance application.

Media guidance applications may be, for example, stand-alone applications implemented on user equipment devices. For example, the media guidance application may be implemented as software or a set of executable instructions which may be stored in storage 308, and executed by control circuitry 304 of a user equipment device 300. In some embodiments, media guidance applications may be client-server applications where only a client application resides on the user equipment device, and server application resides on a remote server. For example, media guidance applications may be implemented partially as a client application on control circuitry 304 of user equipment device 300 and partially on a remote server as a server application (e.g., media guidance data source 418) running on control circuitry of remote server 415. When executed by control circuitry of remote server 415 (such as media guidance data source 418), the media guidance application may instruct the control circuitry to generate the guidance application displays and transmit the generated displays to the user equipment devices. The server application may instruct the control circuitry of the media guidance data source 418 to transmit data for storage on the user equipment. The client application may instruct control circuitry of the receiving user equipment to generate the guidance application displays.

Content and/or media guidance data delivered to user equipment devices 402, 404, and 406 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 400 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices may communicate with each other within a home network. User equipment devices can communicate with each other directly via short-range point-to-point communication schemes described above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 416 to access content. Specifically, within a home, users of user television equipment 402 and user computer equipment 404 may access the media guidance application to navigate among and locate desirable content. Users may also access the media guidance application outside of the home using wireless user communications devices 406 to navigate among and locate desirable content.

In a fourth approach, user equipment devices may operate in a cloud computing environment to access cloud services. In a cloud computing environment, various types of computing services for content sharing, storage or distribution (e.g., video sharing sites, blogs, news sites, or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 414. These cloud resources may include one or more content sources 416 and one or more media guidance data sources 418. In addition or in the alternative, the remote computing sites may include other user equipment devices, such as user television equipment 402, user computer equipment 404, and wireless user communications device 406. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, access to messages posted by users in a crowd, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 404 or wireless user communications device 406 having content capture feature. Alternatively, the user can first transfer the content to a user equipment device, such as user computer equipment 404. The user equipment device storing the content uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 3.

In some embodiments, control circuitry 304 (of a user equipment device or remote server 415) may retrieve a media asset (or portion of the media asset) from storage 308 or receive a live broadcast of the media asset from a content source. Control circuitry 304 may present the media asset and monitor for receipt of verbal input from the user. In response to receiving verbal input from the user, control circuitry 304 may determine whether the verbal input corresponds to an authorized or registered user. When the verbal input is received from an authorized user, control circuitry 304 may process the verbal input to determine whether keywords in the verbal input correspond to a shareable moment (e.g., whether the keywords indicate to control circuitry 304 that the user would like a segment of the media asset to be posted to a social network). In response, control circuitry 304 may store, as a starting position of a segment, a current playback position at the time the verbal input was received or a position that precedes the playback position when the verbal input was received by a predetermined amount (e.g., 20 seconds). Control circuitry 304 may store, as the ending position of the segment, a playback position that follows the playback position when the verbal input was received by a predetermined amount (e.g., 10 seconds). Control circuitry 304 (e.g., of a user equipment device) may generate a media asset segment that includes the portion of the media asset between the starting and ending positions and transmit that segment, optionally with commentary received in the verbal input, to remote server 415.

FIG. 5 shows an illustrative display screen 500 of automatically generating a media asset segment based on verbal input in accordance with an embodiment of the invention. Screen 500 includes a media asset 510, an information overlay 540, and a voice detection region 530.

The media asset displayed in screen 500 may be a linear or non-linear media asset. For example, in some implementations, the media asset may be a live broadcast of an event. A user may be consuming the media asset and provide verbal input to control circuitry 304 about the media asset 510 or control circuitry 304 may monitor biometric information of the user while the user consumes media asset 510. In response to receiving a user request for further information, control circuitry 304 may generate for display information overlay 540. Information overlay 540 may include any information identifying or describing media asset 510 (e.g., a title, detailed description, content rating, etc.) and a transport bar 548. Transport bar 548 may indicate to the user a current position 544 within media asset 510 relative to a start time and an end time of media asset 510.

In some embodiments, control circuitry 304 may monitor for verbal input from the user while the user consumes media asset 510. Control circuitry 304 may continuously or periodically process verbal input received from the user to identify keywords that match keywords stored in a biometric response database. In some embodiments, control circuitry 304 may process verbal input in response to receiving a user selection of visual indicator 520. Specifically, the user may press or select visual indicator 520 while speaking and release the button or unselect indicator 520 when the user finishes speaking. Control circuitry 304 may process the verbal input received during the period of time indicator 520 was actuated or selected by the user. Visual indicator 520 may be displayed persistently or intermittently to allow a user to input a request to provide verbal input. Alternatively, when control circuitry 304 continuously or periodically monitors for verbal input, control circuitry 304 displays indicator 520 to inform the user that a keyword has been detected in verbal input that was being monitored.

In response to determining that a keyword spoken by the user matches one of the keywords in the biometric response database, control circuitry 304 may execute instructions stored in the database that match the spoken keywords. In response to determining that a spoken keyword (detected in the verbal input) matches a keyword in the database, control circuitry 304 may display a visual indication 520 of the detected keyword. In some implementations, visual indication 520 may simply be a microphone indicating that verbal input was detected. Alternatively or in addition, visual indication 520 may include a representation (e.g., textual identification) of the matching keyword.

For example, control circuitry 304 may determine that verbal input received from the user includes the keywords “post to Facebook” and identify the input as corresponding to a shareable moment. The instructions in the biometric response database may indicate that additional verbal input (e.g., comment information) is expected and accordingly control circuitry 304 may store subsequently received words or phrases. In some implementations, control circuitry 304 may store a predetermined number of words that follow the keyword “post to Facebook” as comment information. The instructions in the biometric response database may also indicate to control circuitry 304 to generate a media asset segment within the time frame of when the verbal input was received. Specifically, the instructions may indicate to control circuitry 304 to generate a media asset segment, corresponding to the shareable moment, that includes a portion of media asset 510 that precedes the verbal input by a first predetermined amount of time (e.g., 5 seconds) and follows the verbal input by a second predetermined amount of time (e.g., 6 seconds). The first and second predetermined amounts of time may be the same or different. As referred to above and below, the first predetermined amount of time is an amount of time that precedes an event (e.g., verbal input matching a keyword in a biometric response database) that triggers a shareable moment segment creation and the second predetermined amount of time is an amount of time that follows the event that triggers a shareable moment segment creation.

In response to determining that the verbal input corresponds to a shareable moment, control circuitry 304 may display a visual indicator 542 in transport bar 548 to indicate to the user the relative playback time of when the verbal input was received. In some implementations, control circuitry 304 may display a visual indicator 542 in transport bar 548 to indicate to the user the relative playback time of when the verbal input was received for any verbal input that matches any entry keywords in the biometrics response database.

In some implementations, to generate the media asset segment for the shareable moment, control circuitry 304 may determine whether media asset 510 was being stored (recorded) prior to receipt of the verbal input. When media asset 510 was being stored prior to receipt of the verbal input, control circuitry 304 may continue to record media asset 510 and may automatically extract the portion of the media asset 510 recording that corresponds to the shareable moment. Specifically, control circuitry 304 may extract a portion of the recording that starts at a point that precedes the time when the verbal input was received by the first predetermined amount of time and ends at a point that follows the time when the verbal input was received by the second predetermined amount of time.

When media asset 510 was not being recorded prior to receipt of the verbal input, control circuitry 304 may start storing media asset 510 to create the portion of the media asset 510 that corresponds to the shareable moment. In some implementations, control circuitry 304 may display recording indicator 530 to indicate that the media asset was not being recorded before the verbal input was received but has now automatically started being stored in response to receiving the verbal input. Specifically, control circuitry 304 may start generating the segment of media asset 510 by storing media asset 510 from a point when the verbal input was received and to a point that follows the time when the verbal input was received by the second predetermined amount of time.

Control circuitry 304 may display a visual indicator 546 in transport bar 548 to identify the region of media asset 510 that has been identified and stored as corresponding to the media asset segment of the shareable moment. Visual indicator 546 may be a shaded region, color region or any other suitable identifier that visually distinguishes which region of transport bar 548 corresponds to the media asset segment (e.g., the positions of the start and end points of the media asset segment relative to the start and end point of media asset 510) that has been automatically generated in response to receiving verbal input from the user.

In some implementations, the size of indicator 546 may correspond to the length of the media asset segment. Specifically when the first and second predetermined amounts of time are large values, indicator 546 may be longer or wider as the media asset segment will correspond to a larger portion of media asset 510. Similarly, when the first and second predetermined amounts of time are smaller values, indicator 546 may be shorter or narrower as the media asset segment will correspond to a larger portion of media asset 510. In other words, the size of the media asset segment and hence indicator 546 may be proportional to the size of the first and second predetermined amounts of time.

In some embodiments, control circuitry 304 may monitor biometric input to identify an event corresponding to a shareable moment and generate a media asset segment. For example, control circuitry 304 may monitor biometric information from multiple users to identify the event. Specifically, control circuitry 304 may determine that two or more users start engaging in a conversation while consuming a media asset and in response may automatically generate a media asset segment. Control circuitry 304 may determine that the users are engaging in a conversation when one or any combination of biometric criteria is met including, but not limited to, identifying faces of the users change from facing the display screen to facing each other (e.g., using facial recognition circuitry), verbal input is received from more than one user at a time (simultaneously or substantially simultaneously or within a predetermined amount of time of each other), a position of one or more users in an area of the display screen changes, etc.

In response to identifying the shareable moment event based on the biometric response information, control circuitry 304 may execute instructions stored in the database that match the biometric response information. For example, in response to determining that more than one user's verbal input is received simultaneously or within a predetermined amount of time of each other and/or that the direction which faces of more than one user change from facing the screen to facing each other, control circuitry 304 may display a visual indication indicating that a shareable moment has been identified. The instructions in the biometric response database for this combined biometric response may indicate to control circuitry 304 to process verbal input exchanged between the one or more users and to store the processed words or phrases received in the verbal input from the various users.

The instructions in the biometric response database may also indicate to control circuitry 304 to generate a media asset segment within the time frame of when the event was identified. Specifically, the instructions may indicate to control circuitry 304 to generate a media asset segment, corresponding to the shareable moment, that includes a portion of media asset 510 that precedes the event by a first predetermined amount of time (e.g., 5 seconds) and follows the event by a second predetermined amount of time (e.g., 6 seconds).

In response to identifying the event corresponding to a shareable moment, control circuitry 304 may display visual indicator 542 in transport bar 548 to indicate to the user the relative playback time of when the event was identified. In some implementations, to generate the media asset segment for the shareable moment, control circuitry 304 may determine whether media asset 510 was being stored (recorded) prior to identification of the event. When media asset 510 was being stored prior to identification of the event, control circuitry 304 may continue to record media asset 510 and may automatically extract the portion of the media asset 510 recording that corresponds to the shareable moment. Specifically, control circuitry 304 may extract a portion of the recording that starts at a point that precedes the time when the event was identified by the first predetermined amount of time and ends at a point that follows the time when the event was identified by the second predetermined amount of time.

When media asset 510 was not being recorded prior to identification of the event, control circuitry 304 may start storing media asset 510 to create the portion of the media asset 510 that corresponds to the shareable moment. In some implementations, control circuitry 304 may display recording indicator 530 to indicate that the media asset was not being recorded before the event was identified but has now automatically started being stored in response to identification of the event. Specifically, control circuitry 304 may start generating the segment of media asset 510 by storing media asset 510 from a point when the event was identified and to a point that follows the time when the event was identified by the second predetermined amount of time.

In some embodiments, after control circuitry 304 completes generating the media asset segment, control circuitry 304 may automatically transmit or post the media asset segment to a social network site or blog associated with the user without providing comment information. For example, control circuitry 304 may use voice recognition engine 316 to cross-reference a voice fingerprint of the verbal input with a voice fingerprint database to determine the identity of the user from whom the verbal input was received. Specifically, the system may be configured to store multiple unique voice fingerprints for each user who operates user equipment device 300 along with corresponding identities of those users in the voice fingerprint database. After control circuitry 304 determines the identity of the user from whom the verbal input was received, control circuitry 304 may retrieve a user profile associated with the user. Control circuitry 304 may retrieve from the user profile one or more log-in information for one or more social network sites or blogs associated with the user. Control circuitry 304 may automatically communicate with each of the social network sites or blogs associated with the user to supply the user's credentials (e.g., the log-in information) and transmit or post the generated media asset segment to the social network site or blog. Once the media asset segment has been transmitted or posted to the social network site or blog, friends or other members of the social network site or blog associated with the user may access, download, playback, store or retrieve the media asset segment generated by control circuitry 304.

In some embodiments, after control circuitry 304 completes generating the media asset segment, control circuitry 304 may generate comment information to associate with the media asset segment automatically prior to transmitting or posting the media asset segment to a social network site or blog associated with the user. Control circuitry 304 may automatically derive comment information by parsing the verbal input that initiated the generation of the media asset segment. Alternatively or in addition, control circuitry 304 may receive or request further input from the user to insert the comment information to associate with the generated media asset segment. Control circuitry 304 may automatically communicate with each of the social network sites or blogs associated with the user to supply the user's credentials (e.g., the log-in information) and transmit or post the generated media asset segment along with the associated comment information to the social network site or blog. Once the media asset segment along with the associated comment information has been transmitted or posted to the social network site or blog, friends or other members of the social network site or blog associated with the user may access, download, playback, store or retrieve the media asset segment generated by control circuitry 304 and see the associated comment information.

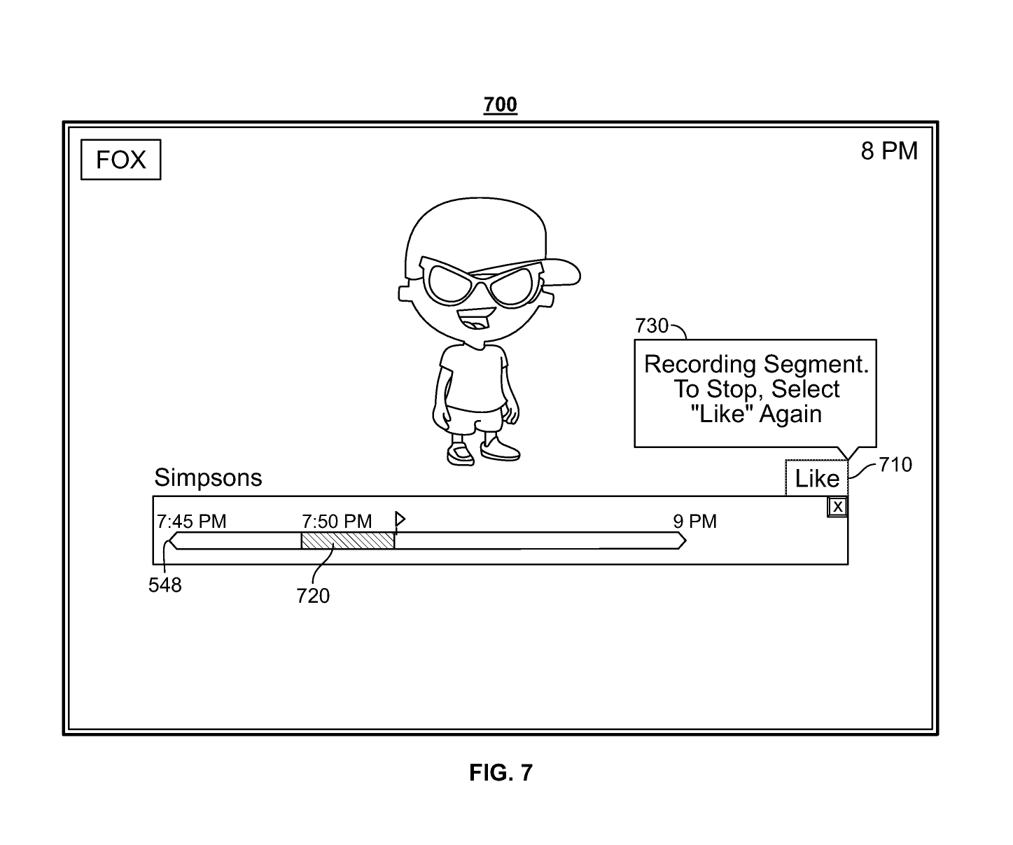

FIG. 6 shows an illustrative display screen 600 of a prompt for an automatically generated media asset segment in accordance with an embodiment of the invention. Screen 600 may include a comment prompt 630 and transport bar 548. Control circuitry 304 may generate prompt 630 after control circuitry 304 completes generating the media asset segment.

In some embodiments, control circuitry 304 may display in transport bar 548, a first indicator 610 and second indicator 620. First indicator 610 may identify a region of the media asset that forms a first portion of the media asset segment that corresponds to the portion of the media asset segment that precedes the time when the verbal input was received or event was identified by the first predetermined amount. Second indicator 620 may identify a region of the media asset that forms a second portion of the media asset segment that corresponds to the portion of the media asset segment that follows the time when the verbal input was received or event was identified by the second predetermined amount.

In some implementations, first and second indicators 610 and 620 may be interactive so as to allow the user to modify the media asset segment. For example, the user may determine that the media asset portion of the segment that precedes the time when the verbal input was received or when the event was identified is not long enough or is too short. Accordingly, the user may drag an edge of indicator 610 in one direction to an earlier point in transport bar 548. Control circuitry 304 may in response increase the size of the media asset segment so that a media asset portion that precedes the current starting point of the segment is included in the media asset segment. For example, the starting point of the media asset segment may initially be a time corresponding to 7:10 PM. In response to receiving a user selection dragging an edge of indicator 610 in one direction to an earlier point (e.g., 7:08 PM), control circuitry 304 may add to the media asset segment the portion of the media asset between 7:08 PM and 7:10 PM. In some implementations, the user may drag an edge of indicator 610 in another direction (e.g., an opposite direction) to a later point in transport bar 548. Control circuitry 304 may in response decrease the size of the media asset segment so that a media asset portion that follows the current starting point of the segment is excluded from the media asset segment. For example, the starting point of the media asset segment may initially be a time corresponding to 7:10 PM. In response to receiving a user selection dragging an edge of indicator 610 in another direction to a later point (e.g., 7:11 PM), control circuitry 304 may remove from the media asset segment the portion of the media asset between 7:10 PM and 7:11 PM.

In some embodiments, the user may determine that the media asset portion of the segment that follows the time when the verbal input was received or when the event was identified is not long enough or is too short. Accordingly, the user may drag an edge of indicator 620 in one direction to a later point in transport bar 548. Control circuitry 304 may in response increase the size of the media asset segment so that a media asset portion that follows the current ending point of the segment is included in the media asset segment. For example, the ending point of the media asset segment may initially be a time corresponding to 7:13 PM. In response to receiving a user selection dragging an edge of indicator 620 in one direction to a later point (e.g., 7:14 PM), control circuitry 304 may add to the media asset segment the portion of the media asset between 7:13 PM and 7:14 PM. In some implementations, the user may drag an edge of indicator 620 in another direction (e.g., an opposite direction) to an earlier point in transport bar 548. Control circuitry 304 may in response decrease the size of the media asset segment so that a media asset portion that precedes the current ending point of the segment is excluded from the media asset segment. For example, the ending point of the media asset segment may initially be a time corresponding to 7:13 PM. In response to receiving a user selection dragging an edge of indicator 620 in another direction to an earlier point (e.g., 7:12 PM), control circuitry 304 may remove from the media asset segment the portion of the media asset between 7:13 PM and 7:12 PM.

In some embodiments, control circuitry 304 may process the received verbal input to generate a string with words/phrases in the verbal input. Control circuitry 304 may parse the string to determine which words/phrases in the string correspond to keywords stored in the voice command database. Control circuitry 304 may separate those words/phrases corresponding to matching keywords from the rest of the words in the string. Control circuitry 304 may mark the remaining words in the string as comment information. Control circuitry 304 may display in prompt 630 the generated string 632 corresponding to the received verbal input. Control circuitry 304 may display in prompt 630 a command detected region 634 and a comment detected region 636. Control circuitry 304 may display in command detected region 636 the instruction matching the keywords in the string corresponding to the instruction. For example, a phrase that matches a keyword, “post to Facebook” may correspond to a website posting instruction, as determined from the voice command database. Accordingly, control circuitry 304 may display in command detected region 634 the corresponding command, “website posting.” Control circuitry 304 may display in comment detected region 636 the remaining words of the string that do not correspond to a keyword of a command or instruction.

In some embodiments, comment detected region 636 may be blank to indicate to the user that comment information was not detected in the verbal input. Control circuitry 304 may receive a user selection of comment detected region 636 and in response may receive textual or verbal input from the user. Control circuitry 304 may process the textual or verbal input to generate a string for use as comment information. Control circuitry 304 may display the generated string in region 636.

Prompt 630 may include an edit option 640, a cancel option 650, a confirm option 660, a redo option 670 and/or view segment option 680. In response to receiving a user selection of edit option 640, control circuitry 304 may enable the user to modify the media asset segment and/or the comment information associated with the media asset segment displayed in region 636. In particular, in response to receiving a user selection of edit option 640, control circuitry 304 may bring the user's attention to indicators 610 and 620 in transport bar 548 (e.g., by blinking or flashing indicators 610 and 620). While indicators 610 and 620 may have not been interactive before the user selection of option 640 was received, control circuitry 304 may cause indicators 610 and 620 to be interactive to enable the user to shorten or lengthen the media asset segment that has been generated in response to receiving selection of option 640. Control circuitry 304 may also allow the user to modify the text in region 636 to insert the desired comment information to associate with the generated media asset segment.

In response to receiving a user selection of cancel option 650, control circuitry 304 may delete the generated media asset segment and/or any associated comment information. Control circuitry 304 may remove prompt 630 from display.

In response to receiving a user selection of confirm option 660, control circuitry 304 may transmit or post the generated media asset segment and the comment information included in comment detected region 636 to a social network site or blog. Specifically, control circuitry 304 may determine the identity of the user from whom the verbal input was received or by receiving further input from the user (e.g., a username and password) and retrieve a user profile associated with the user. Control circuitry 304 may retrieve from the user profile one or more log-in information for one or more social network sites or blogs associated with the user. Control circuitry 304 may automatically communicate with each of the social network sites or blogs associated with the user to supply the user's credentials (e.g., the log-in information) and transmit or post the generated media asset segment along with the corresponding comment information to the social network site or blog.

In response to receiving a user selection of redo option 670, control circuitry 304 may replace or supplement the comment information included in region 636 with new comment information. Specifically, control circuitry 304 may receive verbal input from the user in response to receiving a user selection of option 670. Control circuitry 304 may process the verbal input using voice recognition engine 316 and generate a string of words/phrases. Control circuitry 304 may display the generated string in region 636.

In response to receiving a user selection of view segment option 680, control circuitry 304 may play back the segment of media asset 510 that is identified by indicators 610 and 620 of transport bar 548. The segment may be played back in a small video window or in a full screen display.

In some embodiments, starting and ending positions of a segment within the media asset may automatically be identified and stored by control circuitry 304 in response to receiving user input selecting a “like” option (e.g., a dedicated button or displayed option). In particular, while accessing media asset 510, control circuitry 304 may receive a user input indicating that a user likes a particular section of media asset 510. For example, control circuitry 304 may receive a user selection of a “like” option. Selection of the like option may be used to instruct control circuitry 304 to generate the media asset segment as an alternative or in addition to generating the segment in response to verbal input.

In response to receiving the user selection of the like option, control circuitry 304 may store an indication of a playback position at the time the user input was received. For example, the current playback position may correspond to four minutes after start of the media asset playback and the user selection of the like option may be received at the four minute position. Accordingly, control circuitry 304 may store an indication that the like option was selected at the four minute position (e.g., four minutes from the start of the media asset). Control circuitry 304 may automatically store this indication as a starting position of the segment of the media asset. In some implementations, control circuitry 304 may store, as the starting position of the segment, a position that precedes the position when the like option was selected by the first predetermined amount. In response to receiving a user selection of the like option again (or a de-selection of the like option), control circuitry 304 may determine the playback position at the time the second selection of the like option is received or when the like option was deselected. For example, the playback position when the de-selection of the like option is received (or when the second selection of the like option is received) may be at the six minute position (e.g., six minutes from the start of the media asset). Control circuitry 304 may automatically store this indication as an ending position of the segment of the media asset. In some implementations, control circuitry 304 may store, as the ending position of the segment, a position that follows the position when the like option was de-selected (or selected a second time) by the second predetermined amount.

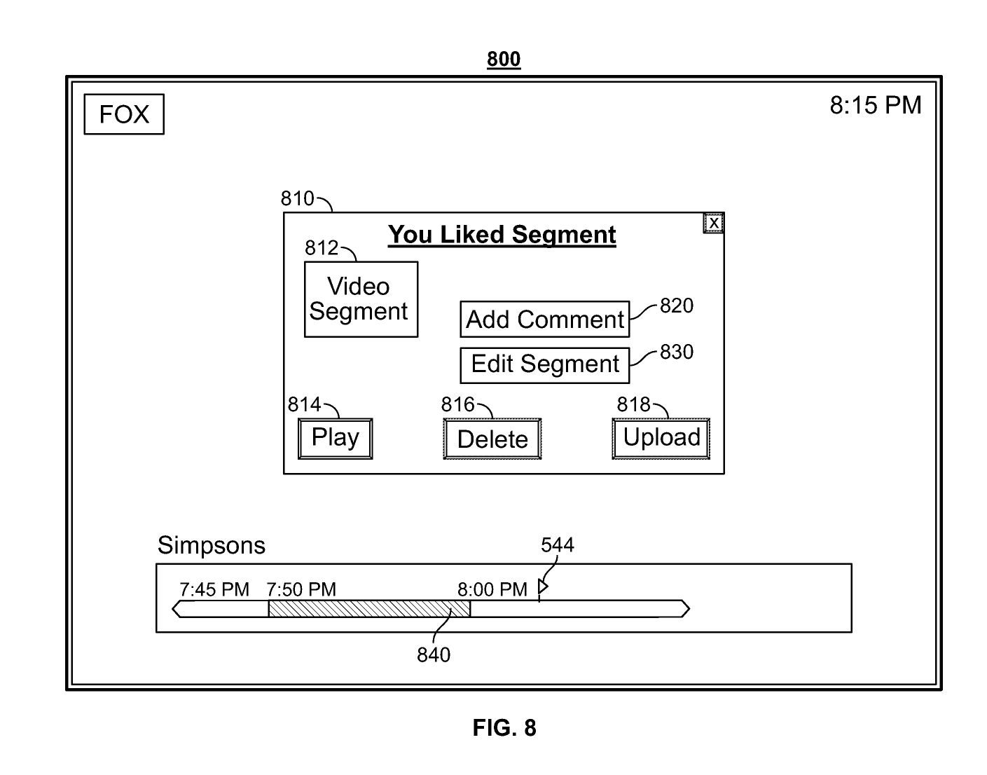

FIG. 7 shows an illustrative display screen 700 of automatic segment generation based on user input in accordance with an embodiment of the invention. Screen 700 may include transport bar 548, a like option 710 and a prompt 730. The media asset displayed in screen 700 may be a linear or non-linear media asset. For example, in some implementations, the media asset may be a live broadcast of an event. A user may be consuming the media asset and control circuitry 304 may receive a user selection of like option 710 while the user consumes the media asset.

In response to receiving the user selection of like option 710, control circuitry 304 may execute instructions to generate a media asset segment, corresponding to the shareable moment. The media asset segment may include a portion of the displayed media asset that precedes the time when control circuitry 304 received the user selection of like option 710 by the first predetermined amount of time (e.g., 5 seconds) and follows the time when control circuitry 304 receives a subsequent user selection of like option 710 by the second predetermined amount of time (e.g., 6 seconds). The region 720 of transport bar 548 may visually distinguish the portion of the media asset that corresponds to the generated media asset segment.

In response to receiving the user selection of like option 710, control circuitry 304 may display a visual indicator in transport bar 548 to indicate to the user the relative playback time of when the user selection was received. In some implementations, to generate the media asset segment in response to receiving the user selection of like option 710, control circuitry 304 may determine whether the media asset displayed in screen 700 was being stored (recorded) prior to receipt of the user selection. When the media asset was being stored prior to receipt of the user selection, control circuitry 304 may continue to record the media asset. Upon receiving a subsequent user selection of like option 710 (or upon determining that like option 710 has been de-selected), control circuitry 304 may automatically extract the portion of the media asset recording that corresponds to the shareable moment (the media asset portion corresponding to a time between selection and de-selection (or subsequent selection) of like option 710). Specifically, control circuitry 304 may extract a portion of the recording that starts at a point that precedes the time when the user selection of like option 710 was received by the first predetermined amount of time and ends at a point that follows the time when a subsequent selection of like option 710 was received by the second predetermined amount of time.

When the media asset displayed in screen 700 was not being recorded prior to receipt of the user selection of like option 710, control circuitry 304 may start storing the media asset to create the portion of the media asset that corresponds to the shareable moment. In some implementations, control circuitry 304 may display prompt 730 to indicate that the media asset was not being recorded before the user selection of like option 710 was received but has now automatically started being stored in response to receiving the user selection of like option 710. Prompt 730 may include a message informing the user that to end recording of the media asset segment corresponding to the shareable moment, the user needs to de-select option 710 or select option 710 again. Specifically, control circuitry 304 may start generating the segment of the media asset by storing the media asset from a point when the user selection of like option 710 was received and to a point that follows the time when a subsequent user selection or de-selection of like option 710 is received by the second predetermined amount of time.

Control circuitry 304 may display visual indicator 720 in transport bar 548 to identify the region of the media asset that has been identified and stored as corresponding to the media asset segment of the shareable moment. Visual indicator 720 may be a shaded region, color region or any other suitable identifier that visually distinguishes which region of transport bar 548 corresponds to the media asset segment (e.g., the positions of the start and end points of the media asset segment relative to the start and end points of the media asset) that has been automatically generated in response to receiving the user selection of option 710.

In some implementations, the size of indicator 720 may correspond to the length of the media asset segment. Specifically when the first and second predetermined amounts of time are large values, indicator 720 may be longer or wider as the media asset segment will correspond to a larger portion of the media asset. Similarly, when the first and second predetermined amounts of time are smaller values, indicator 720 may be shorter or narrower as the media asset segment will correspond to a larger portion of the media asset. In other words, the size of the media asset segment and hence indicator 720 may be proportional to the size of the first and second predetermined amounts of time.

In some implementations, when the media asset has not previously been recorded, control circuitry 304 may generate the segment by storing or recording the portion of the media asset corresponding to the shareable moment (e.g., the portion that precedes and follows a time point when a verbal input was received from the user, a user selection/de-selection of a like option is received, and/or a biometric response is detected). In some implementations, when the media asset has previously been recorded, control circuitry 304 may generate the segment by marking starting and ending positions of the portion of the recorded media asset corresponding to the shareable moment (e.g., the portion that precedes and follows a time point when a verbal input was received from the user or a biometric response is detected).

In some embodiments, control circuitry 304 may complete generating the media asset segment in response to receiving a subsequent user selection of like option 710 or a de-selection of like option 710. Specifically, control circuitry 304 may start generating the media asset segment in response to receiving a first user selection of an option and complete generating the media asset segment in response to receiving a subsequent or additional user selection of the identical option. In response to completing the media asset segment generation, control circuitry 304 may automatically transmit or post the media asset segment to a social network site or blog associated with the user without providing comment information. For example, control circuitry 304 may determine the identity of the user from whom the like option 710 selections were received by, for example, requesting the user to log in. After control circuitry 304 determines the identity of the user from whom the like option 710 selections were received, control circuitry 304 may retrieve a user profile associated with the user. Control circuitry 304 may retrieve from the user profile one or more log-in information for one or more social network sites or blogs associated with the user. Control circuitry 304 may automatically communicate with each of the social network sites or blogs associated with the user to supply the user's credentials (e.g., the log-in information) and transmit or post the generated media asset segment to the social network site or blog. Once the media asset segment has been transmitted or posted to the social network site or blog, friends or other members of the social network site or blog associated with the user may access, download, play back, store or retrieve the media asset segment generated by control circuitry 304.

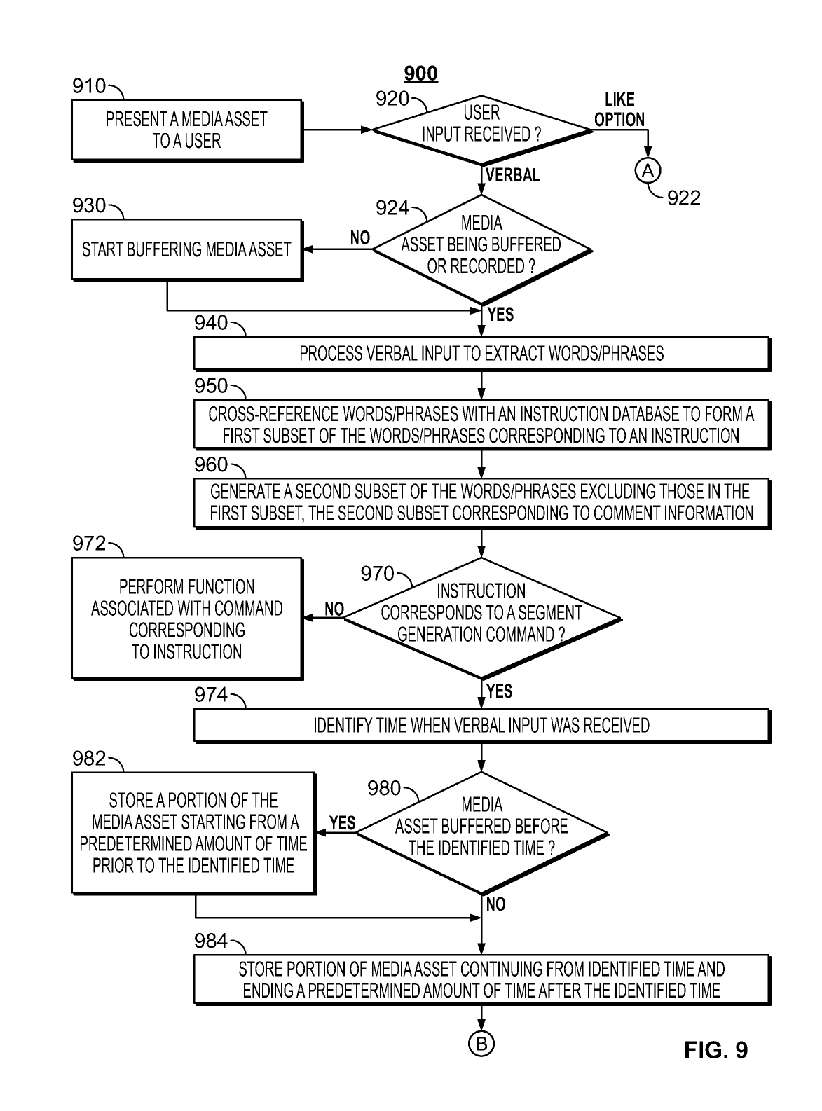

In some embodiments, after control circuitry 304 completes generating the media asset segment, control circuitry 304 may generate comment information to associate with the media asset segment prior to transmitting or posting the media asset segment to a social network site or blog associated with the user. Control circuitry 304 may receive or request further input from the user to insert the comment information to associate with the generated media asset segment. Control circuitry 304 may automatically communicate with each of the social network sites or blogs associated with the user to supply the user's credentials (e.g., the log-in information) and transmit or post the generated media asset segment along with the associated comment information to the social network site or blog. In some implementations, control circuitry 304 may automatically navigate the user to screen 800 (FIG. 8) and request input from the user to insert comment information in response to receiving the subsequent user selection of like option 710 or de-selection of option 710. Once the media asset segment along with the associated comment information has been transmitted or posted to the social network site or blog, friends or other members of the social network site or blog associated with the user may access, download, play back, store or retrieve the media asset segment generated by control circuitry 304 and see the associated comment information.

FIG. 8 shows an illustrative display screen 800 of a comment insertion prompt for a generated media asset segment in accordance with an embodiment of the invention. Screen 800 may include a comment prompt 810 and transport bar 548. Control circuitry 304 may generate prompt 810 after control circuitry 304 completes generating the media asset segment.

In some embodiments, control circuitry 304 may display in transport bar 548, an indicator 840. Indicator 840 may identify a region of the media asset that forms the media asset segment that corresponds to the shareable moment identified by the user with like option 710. In some implementations, indicator 840 may be interactive so as to allow the user to modify the media asset segment. For example, the user may drag an edge of indicator 840 in one direction to an earlier point in transport bar 548. Control circuitry 304 may in response increase the size of the media asset segment so that a media asset portion that precedes the current starting point of the segment is included in the media asset segment. For example, the starting point of the media asset segment may initially be a time corresponding to 7:50 PM. In response to receiving a user selection dragging an edge of indicator 840 in one direction to an earlier point (e.g., 7:49 PM), control circuitry 304 may add to the media asset segment the portion of the media asset between 7:49 PM and 7:50 PM. In some implementations, the user may drag an edge of indicator 840 in another direction (e.g., an opposite direction) to a later point in transport bar 548. Control circuitry 304 may in response decrease the size of the media asset segment so that a media asset portion that follows the current starting point of the segment is excluded from the media asset segment. For example, the starting point of the media asset segment may initially be a time corresponding to 7:50 PM. In response to receiving a user selection dragging an edge of indicator 840 in another direction to a later point (e.g., 7:51 PM), control circuitry 304 may remove from the media asset segment the portion of the media asset between 7:50 PM and 7:51 PM.

Prompt 810 may include an edit segment option 830, an add comment option 820, a delete option 816, an upload option 818, a video window 812 and/or play option 814. In response to receiving a user selection of edit segment option 830, control circuitry 304 may enable the user to modify the media asset segment. In particular, in response to receiving a user selection of edit segment option 830, control circuitry 304 may bring the user's attention to indicator 840 in transport bar 548 (e.g., by blinking or flashing indicator 840). While indicator 840 may have not been interactive before the user selection of option 830 was received, control circuitry 304 may cause indicator 840 to be interactive to enable the user to shorten or lengthen the media asset segment that has been generated in response to receiving the selection of option 830.

In response to receiving a user selection of add comment option 820, control circuitry 304 may allow the user to input comment information. For example, control circuitry 304 may in response display a textual entry region that allows the user to type in textual commentary about the media asset segment. Alternatively or in addition, control circuitry 304 may in response to receiving a user selection of option 820, start recording verbal input from the user and process the verbal input to generate a string corresponding to the verbal input. Control circuitry 304 may store the generated string or information provided in textual entry region as the comment information associated with the media asset segment.

In response to receiving a user selection of delete option 816, control circuitry 304 may delete the generated media asset segment and/or any associated comment information. Control circuitry 304 may remove prompt 810 from display.

In response to receiving a user selection of upload option 818, control circuitry 304 may transmit or post the generated media asset segment and the comment information received in response to a selection of add comment option 820 to a social network site or blog. Specifically, control circuitry 304 may determine the identity of the user by receiving further input from the user (e.g., a username and password) and retrieve a user profile associated with the user. Control circuitry 304 may retrieve from the user profile one or more log-in information for one or more social network sites or blogs associated with the user. Control circuitry 304 may automatically communicate with each of the social network sites or blogs associated with the user to supply the user's credentials (e.g., the log-in information) and transmit or post the generated media asset segment along with the corresponding comment information to the social network site or blog.

In response to receiving a user selection of play option 814, control circuitry 304 may play back the segment of the media asset that is identified by indicator 840 of transport bar 548. The segment may be played back in video window 812 or in a full screen display. In some implementations, video window 812 may display an advertisement or any other video associated with the media asset when video window 812 is not displaying the media asset segment.

In some embodiments, control circuitry 304 may store and index each media asset segment that has been generated in storage 308 (FIG. 3). An option (not shown) to view a list of all media asset segments may be provided in a navigation screen, such as screen 100 or 200 (FIGS. 1 and 2). In response to receiving a user selection of the option to view the list of all media asset segments, control circuitry 304 may generate and display a window or full screen display of media asset listings (similar to grid 102) corresponding to each previously generated media asset segment. Each displayed listing may be interactive and may include a title of the media asset corresponding to the media asset segment. Each displayed listing may include a time marker that indicates the playback time period of the media asset which corresponds to the media asset segment. For example, a media asset, “Family Guy” may have a corresponding media asset segment generated. The media asset may have a 30 minute playback time and the corresponding segment may correspond to the time period spanning 22 minute to 25 minute playback time of the media asset. Accordingly, the media asset listing for the media asset segment may include an indication of the corresponding playback time (e.g., 0:22-0:25 minutes).

Each media asset listing for the media asset segments may include a visual representation of the media asset segment. For example, each media asset listing may include an image, video, graphic or other visual representation that helps the user identify the contents of the media asset segment. In response to receiving a user selection of one of the media asset segment listings, control circuitry 304 may display a prompt with shareable options. Specifically, control circuitry 304 may generate and display prompt 630 or 810 (FIGS. 6 and 8) with options corresponding to the selected media asset segment. Control circuitry 304 may receive user input using the displayed prompt that instructs control circuitry 304 to playback the media asset segment corresponding to the selected media asset listing, edit the media asset segment corresponding to the selected media asset listing, add comment information to associate with the media asset segment corresponding to the selected media asset listing, and/or share (post) the media asset segment corresponding to the selected media asset listing to a social network site or blog similar to the manner described above in connection with FIGS. 6 and 8.

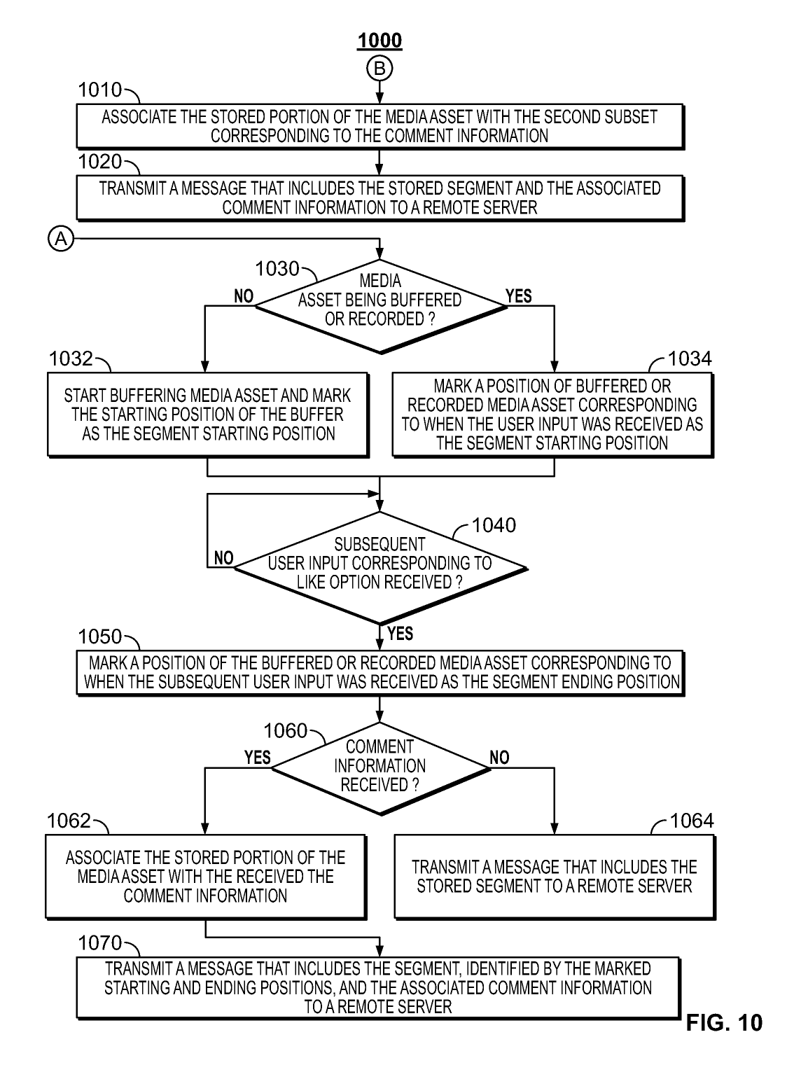

FIGS. 9 and 10 are a diagram of processes 900 and 1000 for generating a media asset segment in accordance with embodiments of the invention. At step 910, a media asset is presented to a user. For example, control circuitry 304 may display media asset 510 on screen 500.

At step 920, a determination is made as to whether user input is received. In response to determining that verbal input (or biometric input corresponding to a shareable moment) is received, the process proceeds to step 924. For example, voice recognition engine 316 of control circuitry 304 may detect verbal input from a user. Alternatively, biometric response engine 318 of control circuitry 304 may detect a biometric response that corresponds to a shareable moment (e.g., two or more users turn away from the screen to face each other and talk). In response to determining that a like option is selected, the process proceeds to step 922 (step 1030 of FIG. 10). For example, control circuitry 304 may detect a user selection of option 710 (FIG. 7).

At step 924, a determination is made as to whether the media asset is being buffered/recorded. In response to determining that the media asset is being buffered/recorded, the process proceeds to step 940, otherwise the process proceeds to step 930.

At step 930, the media asset being presented starts being buffered. For example, control circuitry 304 may start storing the content of the media asset that is presented in storage 308 (FIG. 3).

At step 940, the received verbal input is processed to extract words/phrases. For example, voice recognition engine 316 of control circuitry 304 may perform analog-to-digital conversion on the received verbal input and process the digital information to generate a string of words/phrases included in the verbal input.

At step 950, the words/phrases are cross-referenced with an instruction database to form a first subset of the words/phrases corresponding to an instruction. For example, control circuitry 304 may cross-reference the string of words/phrases with a voice command database. Specifically, control circuitry 304 may generate an SQL query that includes the string of words/phrases and instruct voice command database to determine which of the words/phrases in the string have an entry with words/phrases that match (e.g., are substantially similar) and transmit the SQL query to the voice command database. The voice command database may, in response to receiving the SQL query, transmit or return back to control circuitry 304 an indication of which words/phrases in the string have a matching entry along with the corresponding instruction stored for the matching entry. For example, the command may be displayed for the user in region 634 (FIG. 6).

At step 960, a second subset of the words/phrases is generated that excludes those words/phrases in the first subset, the second subset corresponding to comment information. For example, control circuitry 304 may process the string of words/phrases and remove or extract those words/phrases that match the words/phrases indicated by voice command database to correspond to an instruction. Control circuitry 304 may identify those words/phrases that remain as comment information and display that comment information in comment detected region 636.

At step 970, a determination is made as to whether the instruction corresponds to a segment generation command. In response to determining that the instruction corresponds to a segment generation command, the process proceeds to step 974, otherwise the process proceeds to step 972.

At step 972, a function (e.g., media guidance application function) associated with the command corresponding to the instruction is performed. For example, control circuitry 304 may be informed by the voice command database that the words/phrases in the string correspond to a change channel instruction. Accordingly, control circuitry 304 may perform the function of changing the channel being accessed.

At step 974, a time when the verbal input was received is identified.

At step 980, a determination is made as to whether the media asset was buffered/recorded before the identified time. In response to determining that the media asset was buffered/recorded, the process proceeds to step 982, otherwise the process proceeds to step 984.

At step 982, a portion of the media asset starting from a predetermined amount of time prior to the identified time is stored. For example, control circuitry 304 may store the media asset portion identified by indicator 610 which precedes the time the verbal input was received by the first predetermined amount of time (e.g., 5 seconds).

At step 984, a portion of the media asset continuing from the identified time and ending a predetermined amount of time after the identified time is stored. For example, control circuitry 304 may store the media asset portion identified by indicator 620 which follows the time the verbal input was received by the second predetermined amount of time (e.g., 10 seconds).

At step 1010, the stored portion of the media asset is associated with the second subset of words/phrases corresponding to the comment information.

At step 1020, a message is transmitted to a remote server that includes the stored segment and the associated comment information. For example, control circuitry 304 may retrieve a user profile associated with the user from whom the verbal input was received and determine credentials associated with the user for a social network or blog. Control circuitry 304 may automatically communicate with the social network or blog and post or transmit the message that includes the stored segment and associated comment information. The message may be in the form of an email communication or IP packet transmitted to the website of the social network or blog.

At step 1030, a determination is made as to whether the media asset is being buffered/recorded. In response to determining that the media asset is being buffered/recorded, the process proceeds to step 1034, otherwise the process proceeds to step 1032.

At step 1032, the media asset starts being buffered and the starting position of the buffer is marked as the segment starting position.

At step 1034, a position of the buffered/recorded media asset corresponding to when the user input was received is marked as the segment starting position. For example, control circuitry 304 may mark the position of transport bar 548 corresponding to the left-most portion of indicator 720 as the starting position of the segment in response to receiving a user selection of like option 710 (FIG. 7).

At step 1040, a determination is made as to whether subsequent user input corresponding to the like option is received. In response to receiving subsequent user input, the process proceeds to step 1050, otherwise the process returns to step 1040.

At step 1050, a position of the buffered/recorded media asset corresponding to when the subsequent user input was received is marked as the segment ending position. For example, control circuitry 304 may mark the position of transport bar 548 corresponding to the right most portion of indicator 840 as the ending position of the segment in response to receiving a subsequent user selection or de-selection of like option 710 (FIGS. 7 and 8).

At step 1060, a determination is made as to whether comment information was received. For example, control circuitry 304 may determine whether a user selection of add comment option 820 (FIG. 8) was received to provide and store comment information. In response to determining that comment information is received, the process proceeds to step 1060, otherwise the process proceeds to step 1064.

At step 1062, the stored portion of the media asset is associated with the received comment information.

At step 1070, a message is transmitted to a remote server that includes the stored segment identified by the marked starting and ending positions and the associated comment information. For example, control circuitry 304 may retrieve a user profile associated with the user from whom the verbal input was received and determine credentials associated with the user for a social network or blog. Control circuitry 304 may automatically communicate with the social network or blog and post or transmit the message that includes the stored segment and associated comment information. The message may be in the form of an email communication or IP packet transmitted to the website of the social network or blog.

At step 1064, a message is transmitted to a remote server that includes the stored segment identified by the marked starting and ending positions. For example, control circuitry 304 may retrieve a user profile associated with the user from whom the verbal input was received and determine credentials associated with the user for a social network or blog. Control circuitry 304 may automatically communicate with the social network or blog and post or transmit the message that includes the stored segment. The message may be in the form of an email communication or IP packet transmitted to the website of the social network or blog.

It should be understood, that the above steps of the flow diagrams of FIGS. 9 and 10 may be executed or performed in any order or sequence not limited to the order and sequence shown and described in the figures. Also, some of the above steps of the flow diagrams of FIGS. 9 and 10 may be executed or performed substantially simultaneously where appropriate or in parallel to reduce latency and processing times.

The above-described embodiments of the present disclosure are presented for purposes of illustration and not of limitation, and the present disclosure is limited only by the claims which follow.

1. A method for generating a media asset segment for transmission to a remote server, the method comprising:
receiving verbal input from a user while a media asset is being presented to the user;
processing the verbal input to extract an instruction and comment information included in the verbal input;
cross-referencing the instruction with a command database to determine whether the instruction corresponds to a segment generation command;
in response to determining the instruction corresponds to the segment generation command, generating a segment that includes a portion of the media asset that was presented to the user when the verbal input was received;
associating the comment information with the generated segment; and
transmitting, to the remote server, a message that includes the generated segment and the associated comment information.

2. The method of claim 1, wherein processing the verbal input comprises:
extracting words or phrases from the verbal input; and
cross-referencing the extracted words or phrases with an instruction database that includes a plurality of instructions to identify a first subset of the extracted words or phrases that corresponds to one of the plurality of instructions in the database, wherein the identified instruction is the one of the plurality of instructions;
identifying a second subset of the extracted words or phrases that exclude the words or phrases in the first subset, wherein the comment information includes the second subset.

3. The method of claim 1 further comprising buffering in memory the media asset, wherein generating the segment comprises:
identifying a time when the verbal input was received; and
retrieving a buffered portion of the media asset starting from a first point in time that precedes the identified time by a first predetermined amount and ending at a second point in time that follows the identified time by a second predetermined amount.

4. The method of claim 1, wherein the media asset is transmitted simultaneously to a plurality of users from a content source.

5. The method of claim 1, wherein the remote server enables a plurality of users to view the segment and the associated comment information.

6. The method of claim 1, wherein the remote server identifies a plurality of users associated with the user and enables only the identified plurality of users to view the segment and the associated comment information.

7. The method of claim 1 further comprising:
in response to determining the instruction corresponds to the segment generation command, retrieving social network account information associated with the user; and
automatically accessing the social network based on the account information;
wherein transmitting the message comprises transmitting the message to the social network being accessed.

8. The method of claim 7, wherein the segment and the associated comment information are posted to a news feed on the social network.

9. The method of claim 1 further comprising:
presenting a prompt identifying the message to the user; and
receiving user input confirming transmission of the message, wherein the message is transmitted to the remote server in response to receiving the user input.

10. The method of claim 1 further comprising:
receiving a user request to initiate generation of another segment;
initiating storage of a portion of the media asset in response to receiving the user request;
terminating storage of the portion of the media asset when a subsequent user request to stop generating the another segment is received; and
in response to receiving the subsequent user request, transmitting another message to the remote server that includes the stored portion of the media asset.

11. A system for generating a media asset segment for transmission to a remote server, the system comprising:
control circuitry configured to:
receive verbal input from a user while a media asset is being presented to the user;
process the verbal input to extract an instruction and comment information included in the verbal input;
cross-reference the instruction with a command database to determine whether the instruction corresponds to a segment generation command;
in response to determining the instruction corresponds to the segment generation command, generate a segment that includes a portion of the media asset that was presented to the user when the verbal input was received;
associate the comment information with the generated segment; and
transmit, to the remote server, a message that includes the generated segment and the associated comment information.

12. The system of claim 11, wherein the control circuitry is further configured to:
extract words or phrases from the verbal input; and
cross-reference the extracted words or phrases with an instruction database that includes a plurality of instructions to identify a first subset of the extracted words or phrases that corresponds to one of the plurality of instructions in the database, wherein the identified instruction is the one of the plurality of instructions;
identify a second subset of the extracted words or phrases that exclude the words or phrases in the first subset, wherein the comment information includes the second subset.

13. The system of claim 11, wherein the control circuitry is further configured to:
buffer in memory the media asset;
identify a time when the verbal input was received; and
retrieve a buffered portion of the media asset starting from a first point in time that precedes the identified time by a first predetermined amount and ending at a second point in time that follows the identified time by a second predetermined amount.

14. The system of claim 11, wherein the media asset is transmitted simultaneously to a plurality of users from a content source.

15. The system of claim 11, wherein the remote server enables a plurality of users to view the segment and the associated comment information.

16. The system of claim 11, wherein the remote server identifies a plurality of users associated with the user and enables only the identified plurality of users to view the segment and the associated comment information.

17. The system of claim 11, wherein the control circuitry is further configured to:
in response to determining the instruction corresponds to the segment generation command, retrieve social network account information associated with the user; and
automatically access the social network based on the account information;
transmit the message to the social network being accessed.

18. The system of claim 17, wherein the segment and the associated comment information are posted to a news feed on the social network.

19. The system of claim 11, wherein the control circuitry is further configured to:
present a prompt identifying the message to the user; and
receive user input confirming transmission of the message, wherein the message is transmitted to the remote server in response to receiving the user input.

20. The system of claim 11, wherein the control circuitry is further configured to:
receive a user request to initiate generation of another segment;
initiate storage of a portion of the media asset in response to receiving the user request;
terminate storage of the portion of the media asset when a subsequent user request to stop generating the another segment is received; and
in response to receiving the subsequent user request, transmit another message to the remote server that includes the stored portion of the media asset.

21-30. (canceled)
